(19) United States
(12) Patent Application Publication
(10) Pub. No.: US 2016/0245976 A1
(43) Pub. Date: Aug. 25, 2016

(54) BACKLIGHT MODULE, DISPLAY PANEL AND DISPLAY DEVICE

(71) Applicants: BOE TECHNOLOGY GROUP CO., LTD., Beijing (CN); BOE OPTICAL SCIENCE AND TECHNOLOGY CO., LTD., Suzhou, Jiangsu (CN)

(72) Inventor: Wenjun LI, Beijing (CN)

(21) Appl. No.: 14/786,030

(22) PCT Filed: May 14, 2015
(86) PCT No.: PCT/CN2015/078997

§ 371 Date: Oct. 21, 2015

(30) Foreign Application Priority Data
Sep. 24, 2014 (CN) 201410494679.4

(51) Int. Cl. F21V 8/00

(52) U.S. Cl. CPC G02B 6/0021; G02B 6/0055; G02B 6/0088

(57) ABSTRACT

A backlight module, a display panel and a display device are provided, and the backlight module includes a sealant frame (1), a reflecting plate (2) which is provided within the sealant frame (1) and has a reflective surface (21), and a light guide plate (3) which is arranged on the reflecting plate (2) and has a light exit surface (31) and a light transmission surface (32) opposite to each other as well as a light entrance surface (33) connecting the light exit surface (31) and the light transmission surface (32); and an end, where the light entrance surface (33) is located, of the light guide plate (3) is provided with at least one lap joint portion (34) arranged, in a lap joint manner, on the sealant frame (1) and extending toward the sealant frame (1) that the end faces, and the light transmission surface (32) and the reflective surface (21) of the reflecting plate (2) form a gap layer 4 therebetween. The backlight module can avoid the problems of Newton rings occurred between the light guide plate (3) and the reflecting plate (2) and the occurrence of wavy warpage of the reflecting plate (2) under a high temperature.

### TECHNICAL FIELD

Embodiments of present disclosure relate to a backlight module, a display panel and a display device.

### BACKGROUND

According to the location where a light source is provided, a backlight module includes two kinds of structures, i.e., the direct-light type structure and the side-light type structure. The backlight module of side-light type structure has its light source provided at a lateral side of the backlight module, helps to decrease the thickness of the backlight module and to manufacture a slight flat-panel display, and thus is used widely.

The light source for a backlight module of the side-light type structure can employ, for example, a cold cathode fluorescent lamp (CCFL) or a light-emitting diode (LED). Usually, a light source as mentioned above is provided at one side or both side(s) of a light guide plate of the backlight module. The light guide plate directs the light of the light source so that the light is transmitted from the inside of the light guide plate up to a specified light exit surface, so that the one-dimensional linear light source or point light source emitted from the CCFL or LED is changed into a two-dimensional surface light source. The light guide plate is made of a resin material of high transmissvity, and the light, after entering from a lateral surface of the light guide plate, is subjected to multiple reflection and refraction within the light guide plate and then emits from the light exit surface. Due to the loss of the light generated during the transmitting process, for example, emitting from a non-light exit surface, the utilization efficiency of the light in the backlight module of the side-light type structure can be caused to be lower and this leads to poor luminance for the backlight module. In order to increase the utilization efficiency of the light source, a piece of reflecting plate (Reflector) can be arranged below the light guide plate, so as to reflect the light from the light source or the light diverging from the bottom of the light guide plate back into the light guide plate, and thus to improve the opportunity for the light to emit from the light exit surface of the light guide plate.

### SUMMARY

Embodiments of present disclosure provide a backlight module, a display panel and a display device, so as to solve the problem of the generation of Newton rings between a light guide plate and a reflecting plate of a backlight module due to adsorptive action, and also to overcome the problem that the reflecting plate generates wavy warpage upon being pressed by the light guide plate under a high temperature.

At least one embodiment of the present disclosure provides a backlight module, which comprises a sealant frame, a reflecting plate provided within the sealant frame, and a light guide plate arranged on the reflecting plate, the reflecting plate has a reflective surface, the light guide plate has a light exit surface, a light transmission surface and a light entrance surface, the light exit surface is opposite to the light transmission surface, and the light entrance surface is an end face connecting the light exit surface and the light transmission surface; and an end, where the light entrance surface is located, of the light guide plate is provided with at least one lap joint portion which extends toward the sealant frame that the end faces, the lap joint portion is arranged on the sealant frame in a lap joint manner, and a gap layer is formed between the light transmission surface and the reflective surface of the reflecting plate.

At least one embodiment of the present disclosure provides a display panel comprising the backlight module as provided by the above embodiment.

At least one embodiment of the present disclosure provides a display device, comprising the display panel as provided by the above embodiment.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a partial schematic top view of a backlight module provided by an embodiment of present disclosure;

FIG. 2 is a cross-sectional schematic view of a structure of the backlight module illustrated in FIG. 1 at a location AB;

FIG. 3 is a schematic cross-sectional view of an air layer from an opposite end opposite to a light entrance surface up to the end where the light entrance surface is located, in an embodiment of present disclosure;

FIG. 4 is a schematic top view of a first kind of light guide plate provided by an embodiment of present disclosure;

FIG. 5 is a schematic top view of a second kind of light guide plate provided by an embodiment of present disclosure;

FIG. 6 is an enlarged schematic view of a lap joint portion provided by an embodiment of present disclosure;

FIG. 7 is a schematic cross-sectional view of a structure of the first kind of light guide plate provided by an embodiment of present disclosure;

FIG. 8 is a schematic cross-sectional view of a structure of the second kind of light guide plate provided by an embodiment of present disclosure;

FIG. 9 is a schematic view illustrating reflection of incident light upon a reflecting plate and within a light guide plate; and

FIG. 10 is a schematic view illustrating reflection of incident light upon a reflecting plate and within a light guide plate in an embodiment of present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

In the research, the inventor of the present application noticed that, in a current structure in which a light guide plate and a reflecting plate are attached together, there are the problem that Newton rings are easy to occur due to the adsorption of the light guide plate and the reflecting plate and the problem that the reflecting plate generates wavy warpage upon being pressed by the light guide plate under a high temperature, and such problems can severely influence the quality of the backlight source.

### Embodiment One

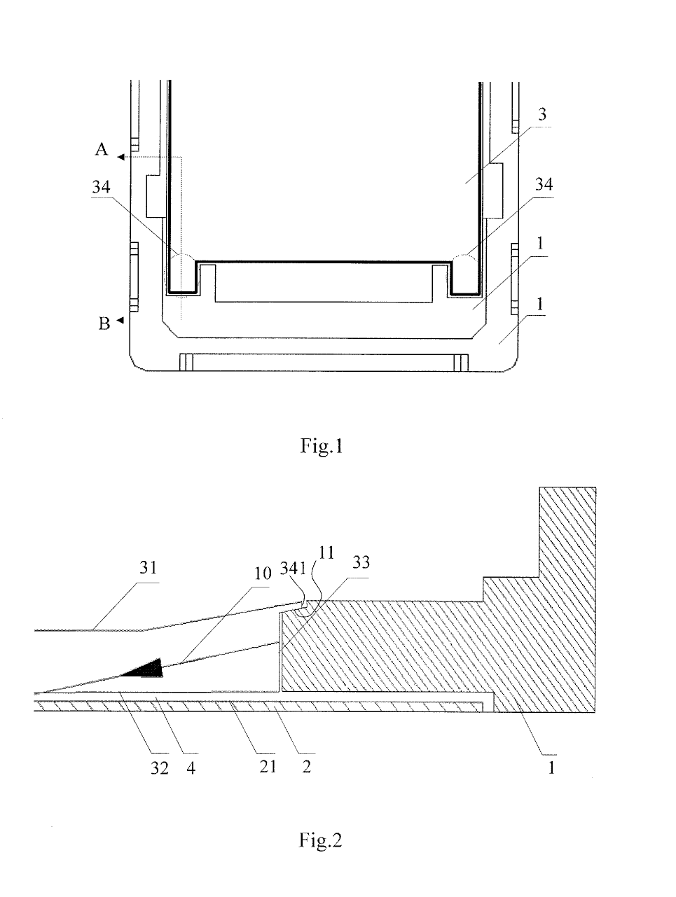

As illustrated in FIG. 1 which is a partial top view of a backlight module and FIG. 2 which is a cross-sectional schematic view of a structure at a location AB of FIG. 1, a backlight module provided by the embodiment of present disclosure includes a sealant frame 1, a reflecting plate 2 arranged within the sealant frame 1, and a light guide plate 3 provided on the reflecting plate 2, the reflecting plate 2 has a reflective surface 21, the light guide plate 3 has a light exit surface 31, a light transmission surface 32 and a light entrance surface 33, the light exit surface 31 is opposite to the light transmission surface 32, and the light entrance surface 32 is an end face connecting the light exit surface 31 and the light transmission surface 32. An end, where the light entrance surface 33 is located, of the light guide plate 3 is provided with at least one lap joint portion 34 which extends toward the sealant frame 1 that the end faces, the lap joint portion 34 is arranged on the sealant frame 1 in a lap joint manner, the end, where the light entrance surface 33 is located, of the light guide plate 3 has a certain distance from the reflecting plate 2, and a gap layer is formed between the light transmission surface 32 and the reflective surface 21 of the reflecting plate 2.

The gap layer is configured to prevent the adsorption of the light guide plate 3 and the reflecting plate 2. For example, the gap layer can be filled with gas, for example, air, and embodiments of present disclosure will be described with respect to the example that an air layer 4 serves as the gap layer.

In at least one example of this embodiment, the lap joint portion 34 can be provided at an upper part of the end, where the light entrance surface 33 is located, of the light guide plate 3, as illustrated in FIG. 2. Of course, the lap joint portion 34 can also be provided at other location of the end where the light entrance surface 33 is located, for example, at a middle part or lower part of this end.

In the embodiment of present disclosure, the light guide plate 3 of the backlight module is provided with a lap joint portion 34, and through the cooperation of the lap joint portion 34 with the sealant frame 1, an air layer 4 is formed between the light guide plate 3 and the reflecting plate 2. Due to employing the cooperation between the lap joint portion 34 and the sealant frame 1, the assembly for the embodiment of present disclosure is simple, and further, the air layer 4 for different design requirements can be obtained by regulating the parameters of the sealant frame 1 or the lap joint portion 34 (for example, the height of the sealant frame, the thickness of the lap joint portion 34, the position of the lap joint portion 34 on the end where the light entrance surface 33 is located, the arrangement of a cushion between the lap joint portion 34 and the sealant frame 1, or the like), and in this way, it is possible to improve the design and assembly efficiency of the backlight module; and on the other hand, the air layer 4 can avoid the Newton rings, between the light guide plate 3 and the reflecting plate 2, generated due to the adsorption, and also, the reflecting plate 2 can not be subjected to pressure from the light guide plate 3, thus eliminating the generation of warpage of the reflecting plate under a high temperature.

In at least one example of this embodiment, an angle can be formed between the light transmission surface 32 and the reflective surface 21, and the angle is an acute angle, that is to say, the light transmission surface 32 is inclined with respect to the reflective surface 21, and in such a case, the air layer 4 has an inclined plane along a direction perpendicular to the reflective surface 21.

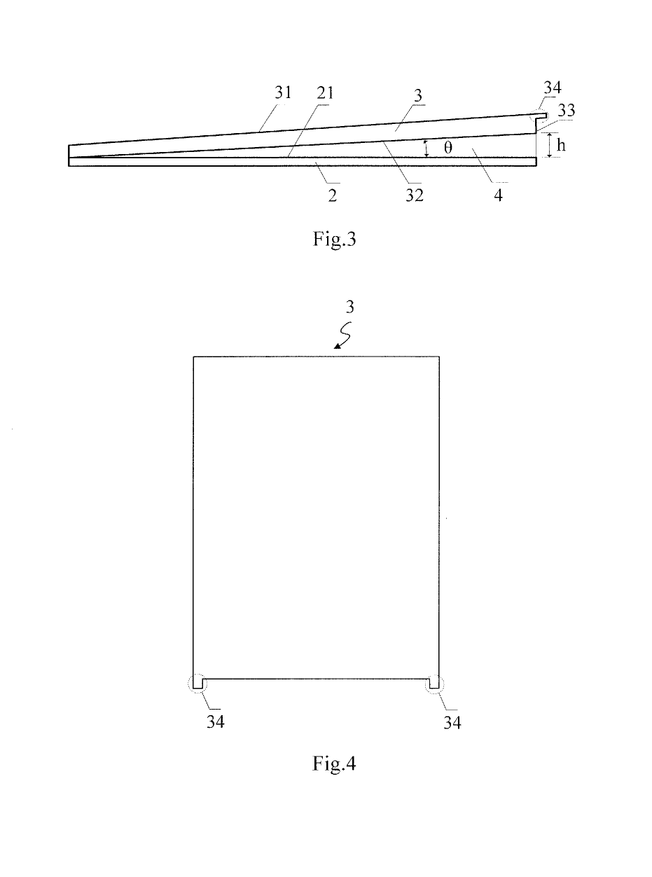

For example, the incident light 10 (in the cross-sectional schematic view illustrated in FIG. 2, the light source providing the incident light 10 is blocked by the sealant frame) enters from the light entrance surface 33, passes through the light guide plate 3 and the air layer 4, and then is reflected by the reflective surface 21. In at least one example of this embodiment, in a direction from an opposite end, which is opposite to the light entrance surface 33, to the end where the light entrance surface 33 is located, the section, perpendicular to the reflective surface 21, of the air layer 4 can be triangular (as illustrated in FIG. 3) or trapezoidal (for example, the opposite end which is opposite to the light entrance surface 33 is also provided with a lap joint portion). For example, the cross section of the air layer 4 is a right triangle, in which one right-angle side is located at the reflective surface 21 and the other one right-angle side is located at the sealant frame 1 that the lap joint portion 34 faces.

As illustrated in FIG. 3 which is a schematic cross-sectional view of the air layer 4 from the opposite end which is opposite to the light entrance surface 33 to the end where the light entrance surface 33 is located, in the direction from the opposite end which is opposite to the light entrance surface 33 to the end where the light entrance surface 33 is located, the section, perpendicular to the reflective surface 21, of the air layer 4 is triangular. In FIG. 3, the light guide plate 3 has a light exit surface 31, a light transmission surface 32 and a light entrance surface 33, the end where the light entrance surface 33 is located is provided with a lap joint portion 34; the reflecting plate 2 has a reflective surface 21; and the light transmission surface 32 and the reflective surface 21 form an angle θ, which is an acute angle, and the light transmission surface 32 and the reflective surface 21 define an air layer 4 of a height h. This height h is perpendicular to the reflective surface 21. For example, this height h is greater than 0 and smaller than or equal to 0.3 mm (millimeter). It is to be noted that this height h is the maximum height of the air layer 4.

In the embodiment of present disclosure, the maximal spacing between the light guide plate 3 and the reflecting plate 2 is within a specified scope, the air layer 4, from the opposite end which is opposite to the light entrance surface 33 to the end where the light entrance surface 33 is located, has a triangular or trapezoidal section, and further the incident light enters from the light entrance surface 33 opposite to the angle formed by the light guide plate 3 and the reflecting plate 2. Thus, the incident light can obtain desirable reflection times upon the reflecting plate 2; the reflection times especially at the distal end, with respect to the light source, of the reflecting plate 2 is more than that at the light source side, which means that more light enters into the distal end of the light guide plate 3 with respect to the light source, and this enables the distal end of the backlight module with respect to the light source presents a higher brightness than a backlight module employing such a structure that a light guide plate and a reflecting plate are attached with each other, so that the entirety of the backlight module provides a more even backlight distribution; and on the other hand, the linear light source (the incident light) is converted into a surface light source to a larger extent, and the linear light source has a higher utilization factor.

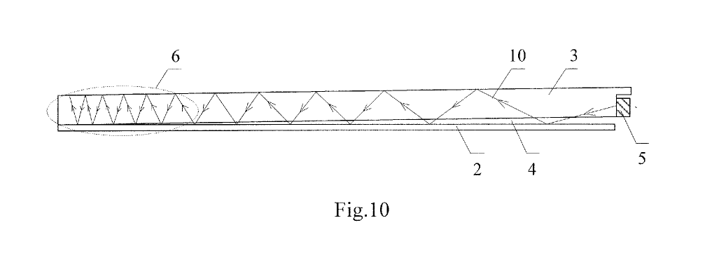

As illustrated in FIG. 9, which illustrates a schematic view of multiple reflection of the incident light 10 within the reflecting plate 2 and the light guide plate 3, the reflecting plate 2 and the light guide plate 3 are attached with each other entirely, and the incident light 10 is reflected for a plurality of times by the reflecting plate 2 and the light guide plate 3, and its reflection path has an even distribution. As to the light guide plate 3, the incident light 10 has its intensity to be higher at the end adjacent to the light source 5, and to reduce gradually as the incident light 10 is subjected to multiple reflection and extends toward the distal end of the light guide plate 3 with respect to the light source 5 (the region as illustrated in dotted line 6), and thus causes a lower brightness at the distal end of the light guide plate 3 with respect to the light source 5, and thus the backlight module provides non-uniform backlight. As illustrated in FIG. 10, in the schematic view illustrating the multiple reflection of the incident light 10 within the reflecting plate 2 and the light guide plate 3, provided by an embodiment of present disclosure, the incident light 10 emitted from the light source 5 is subjected to multiple reflection within the reflecting plate 2 and the light guide plate 3; the light guide plate 3 and the reflecting plate 2 form an air layer 4 of triangular or trapezoidal cross section therebetween, so the air layer 4 enables the incident light 10, upon the incident light 10 being reflected on the reflecting plate 2, to be reflected for more times at the distal end of the reflecting plate 2 with respect to the light source 5 (for example, the region illustrated by dotted line 6), that is to say, at the distal end with respect to the light source 5, the light guide plate 3 can obtain more light incidence opportunity, this increases the overall light intensity in this region (for example, the region show in dotted line 6) and makes the guided light from the light guide plate 3 much more evenly, and thus the backlight module can provide an even backlight.

The location for arranging the lap joint portion 34 of the light guide plate 3 is relatively flexible, and can be varied according to actual requirements. For example, FIG. 4 illustrates a top view of a first kind of light guide plate 3, which includes two lap joint portions 34 arranged respectively on both sides of one end of the light guide plate 3, without going beyond the two sides. Still further, for example, FIG. 5 illustrates a top view of a second kind of light guide plate 3 which includes 4 lap joint portions 34 arranged evenly at one end of the light guide plate 3. However, the number and arrangement of the lap joint portion 34 are not limited thereto, the number of the lap joint portion 34 can be one or more, and the lap joint portion 34 can be arranged evenly or unevenly, as long as an air layer 4 that meets the requirements can be formed between the light guide plate 3 and the reflecting plate 2.

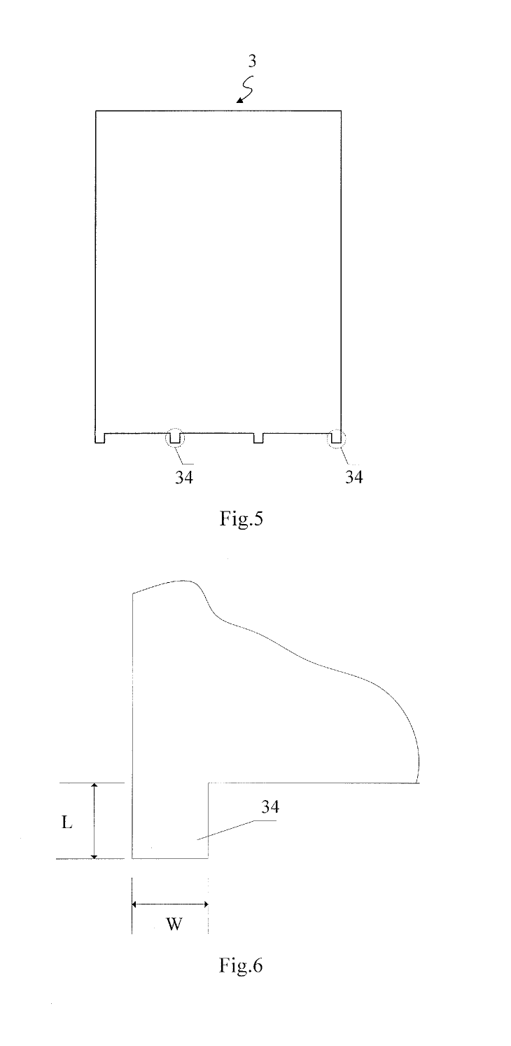

See the enlarged schematic view of the lap joint portion 34 illustrated in FIG. 6. For example, the extending length L of the lap joint portion 34 can be greater than or equal to 0.5 mm, and the width W of the lap joint portion 34 can be set as required. In this embodiment, the extending length, greater than or equal to 0.5 mm, of the lap joint portion 34 allows for an even more reliable cooperation between the lap joint portion 34 and the sealant frame 1.

In order that a satisfactory air layer 4 is obtained when the light guide plate 3, the reflecting plate 2 and the sealant frame 1 cooperate with each other, the light guide plate 3 can be modified, and examples thereof can be found in the follows.

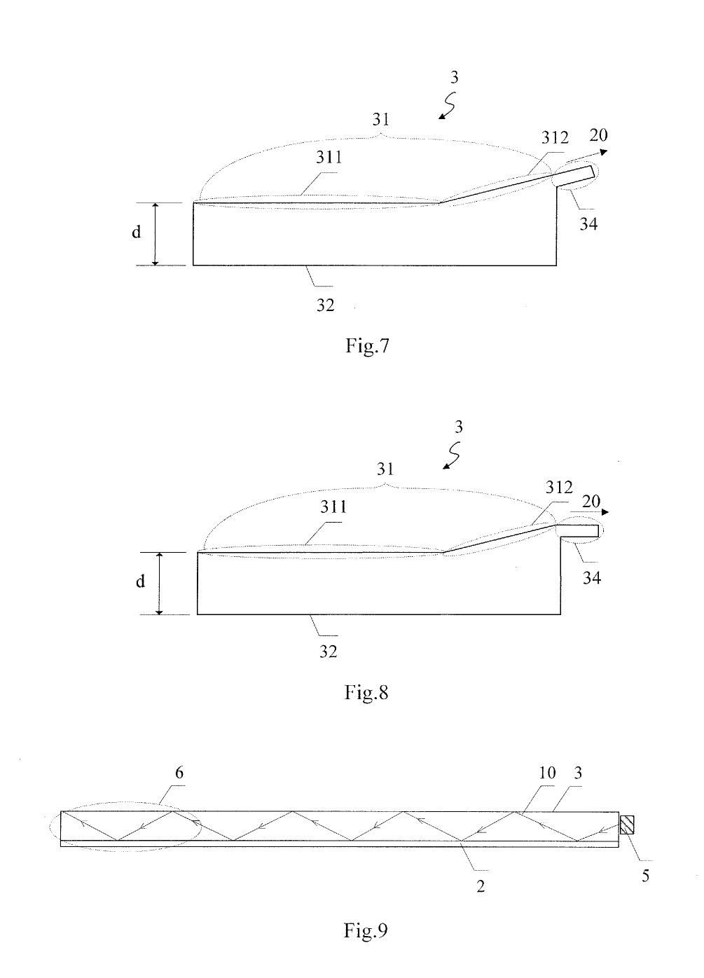

For example, as illustrated in FIG. 7, the light exit surface 31 of the light guide plate 3 includes a first light exit surface 311 and a second light exit surface 312, and the second light exit surface 312 connects the first light exit surface 311 and the light entrance surface 33; the first light exit surface 311 is parallel to the light transmission surface 32, the second light exit surface 312 is tilted with respect to the first light exit surface 311, and the second light exit surface 312 and the light transmission surface 32 form an flared opening expanding outwardly; and the extending direction 20 of the lap joint portion 34 is parallel to the second light exit surface 312.

Moreover, for example, as illustrated in FIG. 8, the light exit surface 31 of the light guide plate 3 includes a first light exit surface 311 and a second light exit surface 312, and the second light exit surface 312 connects the first light exit surface 311 and the light entrance surface 33; the first light exit surface 311 is parallel to the light transmission surface 32, the second light exit surface 312 is tilted with respect the first light exit surface 311, and the second light exit surface 312 and the light transmission surface 32 form an flared opening expanding outwardly; and the extending direction 20 of the lap joint portion 34 is parallel to the first light exit surface 311.

In this embodiment, for example, the thickness of the lap joint portion 34 can be greater than 0 and smaller than or equal to d/2, and d is the thickness of the light guide plate 3 at the region corresponding to the first light exit surface 311. For example, when the light exit surface 31 of the light guide plate 3 is completely parallel to the light transmission surface 32, d is the distance between the light exit surface 31 and the light transmission surface 32. When the light guide plate 3 is the one illustrated in FIG. 7 or 8, d is the thickness of the light guide plate 3 at the region corresponding to the first light exit surface 311, that is, the distance between the first light exit surface 311 and the light transmission surface 32.

For the cooperation of the sealant frame 1 with the lap joint portion 34 of the light guide plate 3, the sealant frame 1 can be modified in its height or chamfer based on the extending direction of the lap joint portion 34 of the light guide plate 3. In at least one example of this embodiment, a groove 11 can further be provided in the sealant frame 1 for receiving the lap joint portion 34, and after the cooperation of the groove 11 with the lap joint portion 34, the gap at a side of the groove 11 (that is, the gap between the groove 11 and each lateral side of the lap joint portion 34) is greater than or equal to 0.1 mm. For example, as illustrated in FIG. 2, the gap between the groove 11 and the lateral side 341, facing the sealant frame 1, of the lap joint portion 34 is greater than or equal to 0.1 mm. In this embodiment, the groove of the sealant frame 1 can restrict the distance of travel of the lap joint portion 34, and when the side gap between the groove and the lap joint portion 34 is greater than or equal to 0.1 mm, it is possible to facilitate the assembly of the lap joint portion 34 with the groove without any excessive relative displacement occurring therebetween.

For example, the backlight module further includes a light source located at a side, where the light entrance surface 33 is located, of the light guide plate 3. The light source can be provided at a position having no influence upon the lap joint between the light guide plate 3 and the sealant frame 1, for example, a position between the lap joint portions 34. For example, the light source is a cold cathode fluorescent lamp or a light-emitting diode.

Of course, the backlight module can further include parts such as a protective plate, a combination of prisms and the like, and repeated description thereof is omitted herein.

The embodiment of present disclosure provides the following beneficial effects: the light guide plate of the backlight module is provided with a lap joint portion, and through the cooperation of the lap joint portion with the sealant frame, an air layer is formed between the light guide plate and the reflecting plate, this avoids the Newton rings, generated due to adsorption, between the light guide plate and the reflecting plate, at the same time, the reflecting plate is unlikely to be pressed by the light guide plate, and this avoids the warpage of the reflecting plate generated at a high temperature; and on the other hand, the air layer is formed based on the cooperation of the lap joint portion with the sealant frame and thus is easy to realize, and it is also possible to regulate the height of the sealant frame according to the need, so as to regulate the height of the air layer formed between the light guide plate and the reflecting plate to meet the requirements of various backlight modules.

### Embodiment Two

The embodiment of present disclosure provides a display panel including the backlight module as provided by the above embodiment.

The embodiment of present disclosure provides the following beneficial effects: the light guide plate of the backlight module is provided with a lap joint portion, and through the cooperation of the lap joint portion with the sealant frame, a gap layer (for example, an air layer) is formed between the light guide plate and the reflecting plate, this avoids the Newton rings, generated due to adsorption, between the light guide plate and the reflecting plate, at the same time, the reflecting plate is unlikely to be pressed by the light guide plate, and this avoids the warpage of the reflecting plate generated at a high temperature; and on the other hand, the gap layer is formed based on the cooperation of the lap joint portion with the sealant frame and thus is easy to realize, and it is also possible to regulate the height of the sealant frame according to the need, so as to regulate the height of the gap layer formed between the light guide plate and the reflecting plate to meet the requirements of various backlight modules.

### Embodiment Three

The embodiment of present disclosure provides a display device including the display panel as provided by the above embodiment. The display device can be any products or parts having display functions such as a liquid crystal display device, an electronic paper, a cell phone, a tablet computer, a television, a display, a notebook computer, a digital photo frame and a navigator.

The embodiment of present disclosure provides the following beneficial effects: the light guide plate of the backlight module is provided with a lap joint portion, and through the cooperation of the lap joint portion with the sealant frame, a gap layer (for example, an air layer) is formed between the light guide plate and the reflecting plate, this avoids the Newton rings, generated due to adsorption, between the light guide plate and the reflecting plate, at the same time, the reflecting plate is unlikely to be pressed by the light guide plate, and this avoids the warpage of the reflecting plate generated at a high temperature; and on the other hand, the gap layer is formed based on the cooperation of the lap joint portion with the sealant frame and thus is easy to realize, and it is also possible to regulate the height of the sealant frame according to the need, so as to regulate the height of the gap layer formed between the light guide plate and the reflecting plate to meet the requirements of various backlight modules.

What are described above is related to the illustrative embodiments of the disclosure only and not limitative to the scope of the disclosure; the scopes of the disclosure are defined by the accompanying claims.

The present application claims the priority of the Chinese Patent Application No. 201410494679.4, filed on Sep. 24, 2014, the entirety of which is incorporated herein by reference as a part of the present application.

1. A backlight module, comprising a sealant frame, a reflecting plate provided within the sealant frame, and a light guide plate provided on the reflecting plate, wherein
the reflecting plate has a reflective surface, the light guide plate has a light exit surface, a light transmission surface and a light entrance surface, the light exit surface is opposite to the light transmission surface, and the light entrance surface is an end face connecting the light exit surface and the light transmission surface; and
an end, where the light entrance surface is located, of the light guide plate is provided with at least one lap joint portion which extends toward the sealant frame that the end faces, the lap joint portion is arranged on the sealant frame in a lap joint manner, and a gap layer is formed between the light transmission surface and the reflective surface of the reflecting plate.

2. The backlight module according to claim 1, wherein an angle is between the light transmission surface and the reflective surface, and the angle is an acute angle.

3. The backlight module according to claim 1, wherein, from an opposite end, which is opposite to the light entrance surface, to the end where the light entrance surface is located, a cross section of the gap layer is triangular or trapezoidal.

4. The backlight module according to claim 1, wherein a cross-section pattern of the gap layer has a height greater than 0 and smaller than or equal to 0.3 mm in a direction perpendicular to the reflective surface.

5. The backlight module according to claim 1, wherein the sealant frame comprises a groove for receiving the lap joint portion, and a gap at a side of the lap joint portion is greater than or equal to 0.1 mm after the lap joint portion is fitted with the groove.

6. The backlight module according to claim 1, wherein an extending length of the lap joint portion is greater than or equal to 0.5 mm.

7. The backlight module according to claim 1, wherein the light exit surface of the light guide plate comprises a first light exit surface and a second light exit surface, and the second light exit surface connects the first light exit surface and the light entrance surface;
the first light exit surface is parallel to the light transmission surface, the second light exit surface is inclined with respect to the first light exit surface, and the second light exit surface and the light transmission surface form a flared opening expanding outwardly; and
an extending direction of the lap joint portion is parallel to the second light exit surface, or an extending direction of the lap joint portion is parallel to the first light exit surface.

8. The backlight module according to claim 7, wherein a thickness of lap joint portion is greater than 0 and smaller than or equal to d/2, where d is a thickness of the light guide plate in a region corresponding to the first light exit surface.

9. The backlight module according to claim 1, further comprising a light source, wherein the light source is arranged at a side, where the light entrance surface is located, of the light guide plate.

10. A display panel, comprising the backlight module according to claim 1.

11. A display device, comprising the display panel according to claim 10.

12. The backlight module according to claim 2, wherein from an opposite end, which is opposite to the light entrance surface, to the end where the light entrance surface is located, a cross section of the gap layer is triangular or trapezoidal.

13. The backlight module according to claim 2, wherein a cross-section pattern of the gap layer has a height greater than 0 and smaller than or equal to 0.3 mm in a direction perpendicular to the reflective surface.

14. The backlight module according to claim 2, wherein the sealant frame comprises a groove for receiving the lap joint portion, and a gap at a side of the lap joint portion is greater than or equal to 0.1 mm after the lap joint portion is fitted with the groove.

15. The backlight module according to claim 2, wherein an extending length of the lap joint portion is greater than or equal to 0.5 mm.

16. The backlight module according to claim 2, wherein the light exit surface of the light guide plate comprises a first light exit surface and a second light exit surface, and the second light exit surface connects the first light exit surface and the light entrance surface;
the first light exit surface is parallel to the light transmission surface, the second light exit surface is inclined with respect to the first light exit surface, and the second light exit surface and the light transmission surface form a flared opening expanding outwardly; and
an extending direction of the lap joint portion is parallel to the second light exit surface, or an extending direction of the lap joint portion is parallel to the first light exit surface.

17. The backlight module according to claim 3, wherein the light exit surface of the light guide plate comprises a first light exit surface and a second light exit surface, and the second light exit surface connects the first light exit surface and the light entrance surface;
the first light exit surface is parallel to the light transmission surface, the second light exit surface is inclined with respect to the first light exit surface, and the second light exit surface and the light transmission surface form a flared opening expanding outwardly; and
an extending direction of the lap joint portion is parallel to the second light exit surface, or an extending direction of the lap joint portion is parallel to the first light exit surface.

18. The backlight module according to claim 4, wherein the light exit surface of the light guide plate comprises a first light exit surface and a second light exit surface, and the second light exit surface connects the first light exit surface and the light entrance surface;
the first light exit surface is parallel to the light transmission surface, the second light exit surface is inclined with respect to the first light exit surface, and the second light exit surface and the light transmission surface form a flared opening expanding outwardly; and
an extending direction of the lap joint portion is parallel to the second light exit surface, or an extending direction of the lap joint portion is parallel to the first light exit surface.

19. The backlight module according to claim 5, wherein the light exit surface of the light guide plate comprises a first light exit surface and a second light exit surface, and the second light exit surface connects the first light exit surface and the light entrance surface;
the first light exit surface is parallel to the light transmission surface, the second light exit surface is inclined with respect to the first light exit surface, and the second light exit surface and the light transmission surface form a flared opening expanding outwardly; and
an extending direction of the lap joint portion is parallel to the second light exit surface, or an extending direction of the lap joint portion is parallel to the first light exit surface.

20. The backlight module according to claim 6, wherein the light exit surface of the light guide plate comprises a first light exit surface and a second light exit surface, and the second light exit surface connects the first light exit surface and the light entrance surface;
the first light exit surface is parallel to the light transmission surface, the second light exit surface is inclined with respect to the first light exit surface, and the second light exit surface and the light transmission surface form a flared opening expanding outwardly; and
an extending direction of the lap joint portion is parallel to the second light exit surface, or an extending direction of the lap joint portion is parallel to the first light exit surface.
